(19) United States
(12) Patent Application Publication
(10) Pub. No.: US 2014/0014388 A1
(43) Pub. Date: Jan. 16, 2014

(54) OFFSHORE POWER GENERATION PLANT AND INSTALLATION METHOD

(71) Applicant: Voith Patent GmbH, Heidenheim (DE)

(72) Inventor: Wolfgang Maier, Nattheim (DE)

(21) Appl. No.: 13/937,554

(22) Filed: Jul. 9, 2013

(30) Foreign Application Priority Data
Jul. 10, 2012 (DE) 10 2012 013 618.8

(51) Int. Cl. H02G 9/06; H02G 1/14

(52) U.S. Cl. CPC H02G 9/06; H02G 1/14
USPC 174/37; 29/825

(57) ABSTRACT

An offshore power generation plant includes: a power transducer driven by fluid movement; an electric generator, which is at least indirectly driven by the power transducer; an electrical connection cable for the power transmission; and a pile foundation, including a foundation pile, which extends below the ocean bed. The invention is characterized in that a cable passage is arranged on the foundation pile below the ocean bed, which extends through an outer wall of the foundation pile and through which the electrical connection cable is guided.

### BACKGROUND OF THE INVENTION

1. Field of the Invention

The invention relates to an offshore power generation plant having the following features: an offshore power generation plant including: a power transducer driven by a fluid movement; an electric generator, which is at least indirectly driven by the power transducer; an electrical connection cable for power transmission; and a pile foundation, including a foundation pile, which extends under the ocean bed. The invention also relates to an installation method for the connection of an electrical connection cable for power transmission to an offshore power generation plant.

2. Description of the Related Art

Offshore power generation plants which use the kinetic energy of a fluid movement at an ocean location to obtain power are known in various embodiments. These can be ocean current power plants, in particular tidal power plants and wave power plants, wherein a rotating or oscillating power transducer on a freestanding plant is driven by an ocean current. Furthermore, offshore wind power plants are included in this plant type. One possible construction of plants according to the species is represented by horizontal rotor turbines mounted on a nacelle, which at least indirectly drive an electrical generator within the nacelle. The nacelle is typically placed on a tower of the plant, which rests on a foundation on the ocean bed. The present case relates to offshore power generation plants having a foundation in the form of a pile foundation, which comprises at least one foundation pile which extends below the ocean bed. A single foundation pile (monopile) can be used for a sufficiently compacted ocean floor. For this purpose, reference is made to DE 103 40 088 A1, for example. Alternatively, a pile foundation can have multiple foundation piles extending into the ocean floor. An example of such a foundation structure in the form of a tripod is disclosed by DE 10 2004 042 066 A1.

The electrical power generated by an offshore power generation plant is conducted away from the plant by means of an undersea cable. The cable can be led out from the nacelle along the outer side of the support structure. Pipes or trough-shaped receptacle systems are used to protect the cable, which ensure a cable deflection in the horizontal direction in the region of the ocean floor. These cable guiding systems are designated as J-tubes. DE 10 2008 020 964 A1 and WO 02/066828 A1 are mentioned as examples. Alternatively, the electrical connection cable for power transmission can be guided within a closed support structure. Reference is made for this purpose to EP 1 985 845 B1, which describes an undersea cable feedthrough on the tower, which is located in the range of 3.5-5 m above the ocean floor. Such cable feedthroughs on the tower are typically embodied as encapsulated watertight, as described in GB 2479771 A and WO 2009/000322 A1.

To protect the electrical connection cable extending away from the tower, embedding in the ocean floor can be performed. The induction of undersea cables by means of a high pressure water jet is known. Furthermore, cable laying by means of a milling tool is described by JP 06141430 A. An alternative for protecting an undersea cable between two offshore wind power plants of a park is disclosed by WO 2012/008833 A2. The cable guiding on the plants themselves is performed by means of J-tubes. Therefrom, the electrical connection cable extends in direct proximity to the plant on the ocean floor up to an inlet of a bore channel, which is provided by means of a horizontally controlled drilling method and extends from an apron of a first plant up to the proximity of a second plant. A drilling device lowered onto the ocean bed is used to execute the boreholes.

To introduce an electrical connection cable into an access opening in the tower of an offshore power generation plant, which lies below the water level and above the ocean bed, WO 2011/141494 A1 proposes the use of a diving robot (ROV—remotely operated vehicle) which firstly attaches an insertion and securing device in the region of the cable entry opening on the tower, by which device the actual connection cable is advanced into the interior of the tower, which is flooded with water.

Furthermore, storing an electrical connection cable for an offshore wind power plant on a cable drum in the tower or in the foundation is known from EP 1145397 B1. In order to produce an electrical connection to a neighboring plant of a park, the electrical connection cable is drawn out of an opening on the tower, which lies above the ocean bed, and brought by means of a dragline to the next plant.

The previously known devices and methods for installing and guiding an electrical connection cable from an offshore power generation plant to a feed point or transformer point or to an adjacent plant of a park have the disadvantage represented by the complex cable installation, which requires the use of divers or ROVs. Furthermore, in the event of a strong current in the body of water, the danger exists that the known external structures for cable securing, such as J-tubes or seal glands attached on the tower, have a limited lifetime because of the continuous load change caused by the varying incident flow.

The present invention is based on the problem of designing an offshore power generation plant having a pile foundation in such a manner that the electrical connection cable for power transmission is protected over the entire cable length. In particular, no cyclically alternating loads are to act on the electrical connection cable. Furthermore, a method for the electrical connection of an offshore power generation plant is to be specified, so that the laying of the electrical connection cable can be executed in a simpler and safer manner.

### SUMMARY OF THE INVENTION

The present invention provides an offshore power generation plant including: a power transducer driven by a fluid movement; an electric generator, which is at least indirectly driven by the power transducer; an electrical connection cable for power transmission; and a pile foundation, including a foundation pile, which extends under the ocean bed; characterized in that a cable passage, which extends through an outer wall of the foundation pile and through which the electrical connection cable is guided, is arranged on the foundation pile below the ocean bed. The present invention also provides a method for the electrical connection of an offshore power generation plant, including: a power transducer driven by fluid movement; an electrical generator, which is at least indirectly driven by the power transducer; and a pile foundation, including a foundation pile, which extends under the ocean bed; characterized in that an electrical connection cable for power transmission is drawn below the ocean bed through a cable passage, which extends through an outer wall of the foundation pile.

The starting point of the solution of the above-mentioned problem is an offshore power generation plant having a pile foundation. Accordingly, at least one foundation pile is provided, which extends into the ocean floor. For a monopile, the entire plant rests on a single foundation pile. However, the use of multiple foundation piles connected to one another via the ocean floor or a combined foundation, for which, in addition to the foundation pile extending below the ocean floor, further support units, for example, gravity elements or cable anchors, are provided, is also conceivable.

According to the invention, the electrical connection cable, which transmits the power generated by an electric generator of the offshore power generation plant, is guided in the foundation pile up to a cable passage, which lies below the ocean bed. Accordingly, the electrical connection cable extends through the outer wall of the foundation pile at a predetermined depth in the ocean floor, so that a good protection of the cable is provided against current forces and further risks, such as anchor damage. The ocean bed at the foundation pile is understood as the mean level of the ocean floor, i.e., a positionally and chronologically averaged sediment level in a circle around the plant, which corresponds to the rotor diameter. Accordingly, the mean level of the ocean floor represents the height reference which is used to determine the penetration depth of the foundation pile below the ocean bed.

The cable passage, through which the electrical connection cable is guided on the foundation pile, preferably lies at a depth below the ocean bed such that stable soil conditions are provided and therefore in a region for which no sediment transport occurs because of the surrounding current. The selected exit depth of the cable passage below the ocean bed is dependent on the prevailing current and soil conditions. A cable passage is preferably created such that it lies at least 3 m below the ocean bed. In case of a rocky subsurface, the location of the cable passage can be created at a lesser depth under the ocean bed in comparison to a location having a sandy or clayey subsurface. Furthermore, it is preferable to arrange the cable passage such that it lies below the zone of higher notch load on the foundation pile. Therefore, a cable passage is advantageous which is located in the region of the lower two-thirds of the penetration depth of the foundation pile into the ocean floor. The lower third of the penetration depth of the foundation pile under the ocean bed is particularly preferably used for the creation of the cable passage.

For a preferred refinement, the electrical connection cable is guided within the foundation pile up into a dry inner region of the plant, in which a connection element for the electrical connection cable is arranged. The dry inner region is particularly preferably designed as a watertight closable compartment in the region of the foundation pile, which allows the access of service technicians. In addition to the connection element, at which the electrical connection cable can be contacted by simple terminals, the power electronics of the plant can be housed within the compartment. These can include rectifiers and a transformer. Furthermore, it is preferable to arrange further assemblies of the plant, in particular hydrostatic components, sensory components, and components used for the controller, within the dry inner region.

For a preferred embodiment, the cable passage opens outside the foundation pile into a cable tunnel, which also extends below the ocean bed. The cable tunnel is considered to be part of the offshore power generation plant. The cable tunnel is particularly preferably implemented as pressure resistant, liquid tight, and self-drying. For a further advantageous embodiment, the internal diameter of the cable tunnel is selected such that it is greater than the external diameter of the electrical connection cable laid therein. The dry-laid electrical connection cable can therefore be guided with a reduced cable capacitance.

For a preferred embodiment, it is provided that the cable tunnel is designed as traversable and/or a transport device is provided therein, for example, a carriage system for material and/or personnel transport. If the cable tunnel is connected up to a central entrance point of a park or to an access tunnel leading onto land, an access possibility to the plant exists. If such a cable tunnel is combined with a plant variant for which a dry inner region is provided in the interior of the foundation pile, an access possibility exists via a cable passage, which is implemented as correspondingly large for this case, so that installation and service measures can be carried out by human operating personnel.

For the case of a traversable cable tunnel or a cable tunnel equipped for personnel transport, it must have a watertight tunnel lining, for example, by steel pipe segments, for safety reasons. Furthermore, bulkheads for secure partitioning of individual cable tunnel sections and a ventilation system are provided.

For a simplified embodiment variant, the inner region of the foundation pile which adjoins the cable passage below the ocean bed is flooded. For this embodiment, a cable guiding device, which is arranged in the interior of the foundation pile, is preferably provided, which guides an electrical connection cable, which is inserted through the cable passage from outside into the plant, to a plug device. An embodiment is preferred for which the plugging-in procedure is executed by an automated or remote-controlled actuator, so that divers do not have to be used for the installation.

For the method according to the invention for preparing the electrical connection of an offshore power generation plant, an electrical connection cable for power transmission is drawn through a cable passage in the outer wall of the foundation pile, which is arranged under the ocean bed. Particularly preferably, the foundation pile is erected first and cemented in depending on the soil conditions. The cable passage is only opened under the ocean bed in a following method step.

The cable passage is particularly preferably created by means of a through borehole of the outer wall of the foundation pile. A through-drilling point can be provided on the foundation pile, which is created as a concrete wall without steel reinforcement, for example, which can be drilled by a standard drill head of a horizontal drilling machine. Furthermore, it is conceivable to create the foundation pile as a steel pipe and to provide a breakthrough of the steel external envelope for the through-drilling point and to provide a liquid-tight cover which can be drilled by means of a masonry drill, wherein a concrete inner lining can fulfill this purpose.

If a drilling method is used to open the cable passage after the erection of the foundation pile, this can be performed outward from the bored pile. For this purpose, a drilling device is lowered into the interior of the foundation pile or is preinstalled therein before the erection of the foundation pile. Alternatively, the possibility exists of docking the drilling device on the foundation pile, wherein it is advantageous for this embodiment to use a centering device within the foundation pile, in order to guide the drill bit to the through-drilling point located below the level of the ocean floor.

For a particularly preferred embodiment, after the erection of the foundation pile, horizontally controlled drilling is executed from the outside and the outer wall of the foundation pile is broken through at a through-drilling point provided for this purpose for the creation of the cable passage. The horizontally controlled drilling can be performed by a drilling device which is placed in the surrounding region of the offshore power generation plant on the ocean bed.

An embodiment is particularly preferred having a horizontally controlled borehole executed in the dry state. For this purpose, a tunnel extending up to land can be created for the park access, whose cross-section is selected as sufficiently large that a horizontal drilling machine can be constructed therein. It is conceivable to create expanded cavities in the tunnel at the operating regions of the drilling device, which allow the handling of the drill pipe. From these operating points, the application of horizontally controlled drilling in the dry state is performed, in order to advance cable channels up to the through-drilling points at a foundation pile of an offshore power generation plant and the cable passage adjoining thereon at the outer wall of the foundation pile. A liquid-tight tunnel lining for the existing pressure conditions is preferably created during the creation of the cable tunnel. This can be created in segments. The connection between the cable tunnel and the cable passage at the foundation pile is sealed accordingly.

For a simplified method for providing an electrical connection according to the invention of an offshore power generation plant, a cable passage is created on the foundation pile before the insertion into the ocean floor. The insertion of the foundation pile is performed with a penetration depth into the ocean floor and an orientation selected such that the cable passage which is already prefinished on the foundation pile aligns in the final installation position with a cable tunnel created below the ocean bed. The inner region of the foundation pile in the region of the cable passage and the cable tunnel extending away from the plant can be implemented as water-conducting. The laying of the electrical connection cable is then executed by diving robots.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows an offshore power generation plant according to the invention in a side view in partial section;

FIG. 2 shows an enlarged detail from FIG. 1 having a cable tunnel adjoining the foundation pile under the ocean bed;

FIG. 3 shows a production method for a cable passage according to the invention on the foundation pile under the ocean bed by means of a horizontally oriented drilling method, which is performed from an access tunnel under the ocean bed;

FIG. 4 shows a horizontally oriented drilling method originating from the ocean bed for opening a channel passage according to the invention, which is located under the ocean floor, on the foundation pile;

FIG. 5 shows an embodiment variant for which the cable passage according to the invention on the foundation pile is executed in the region of the foundation base by a drilling device positioned inside the offshore power generation plant; and

FIG. 6 shows an embodiment variant having a prefinished cable passage on the foundation pile, which is created before the insertion of the foundation pile into the ocean floor.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

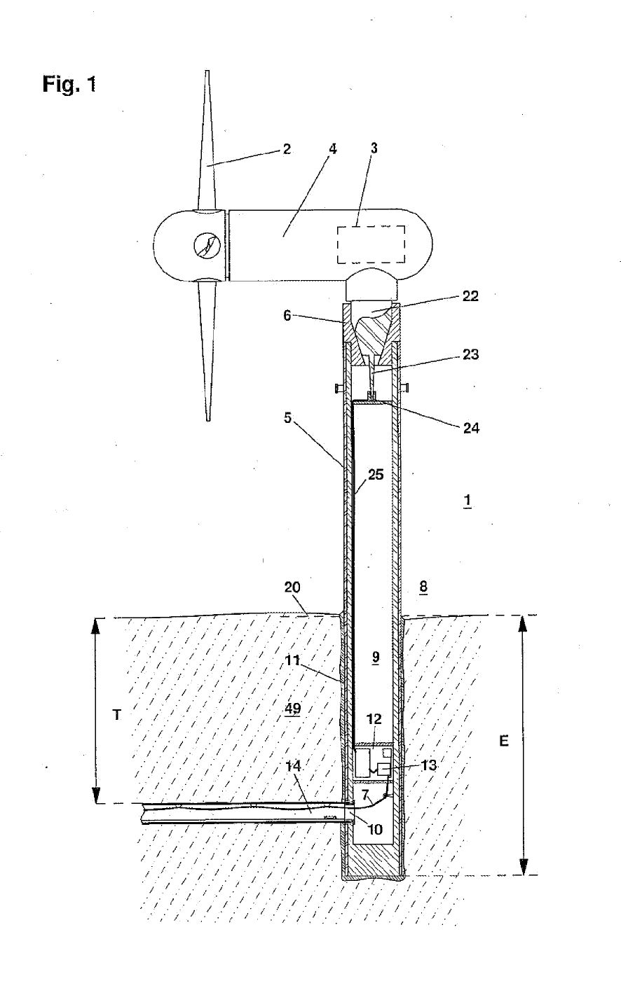

FIG. 1 shows, in schematically simplified form, an offshore power generation plant 1, which is implemented for the present exemplary embodiment as a completely submersed, freestanding tidal power plant. A propeller-shaped rotor is used as the power transducer 2. This can have a profile which can have bidirectional incident flow, so that operation under cyclically alternating incident flow directions for the ebb and flow is possible without a movement of the plant. Alternatively, the rotor blades can be equipped with a pitch adjustment mechanism, or a rotation device is provided for tracking the plant around a vertical axis.

For the embodiment shown in FIG. 1, the rotor-shaped power transducer 2 is designed as a horizontal rotor and is mounted in a nacelle 4. An electric generator 3, which is shown by dashed lines in FIG. 1, is housed inside the nacelle 4. This generator is at least indirectly driven by the power transducer 2, wherein details of the drivetrain between the power transducer 2 and the electric generator 3 are not shown in FIG. 1. A direct drive having a rotationally-fixed coupling between the rotor of the electric generator 3 and the power transducer 2 is preferred in particular. Alternatively, mechanical, electrostatic, or hydrodynamic transmissions can be interposed for the indirect power transmission in the drivetrain.

For the present exemplary embodiment, the offshore power generation plant 1 is constructed modularly. The nacelle 4 is placed on a tower 5 of the plant, which is used as a support structure. For this purpose, a tower adapter 22 adjoins the nacelle 4. This adapter has a complementary shape to a coupling device 6 on the tower, so that the nacelle 4 can be placed during the plant setup on the tower 5 and, secured during operation by its intrinsic weight, rests received in a formfitting manner in the coupling device 6 during operation. Further recovery of the nacelle 4 having the power transducer 2 for service purposes is possible by lifting it off of the tower 5.

The offshore power generation plant shown in FIG. 1 has a pile foundation 8 having a single foundation pile 9, which extends with a penetration depth E from the ocean bed 20 into the ocean floor 49. For the embodiment shown, the pile foundation 8 is implemented as a monopile, wherein the foundation pile 9 and the tower 5 are created in one piece. Alternatively, the possibility exists that the tower 5 represents a separate component, which is fastened on the pile foundation 8. Such an embodiment is selected if the power transducer 2 has a greater distance to the ocean bed 20. This is the case in particular for offshore wind power plants.

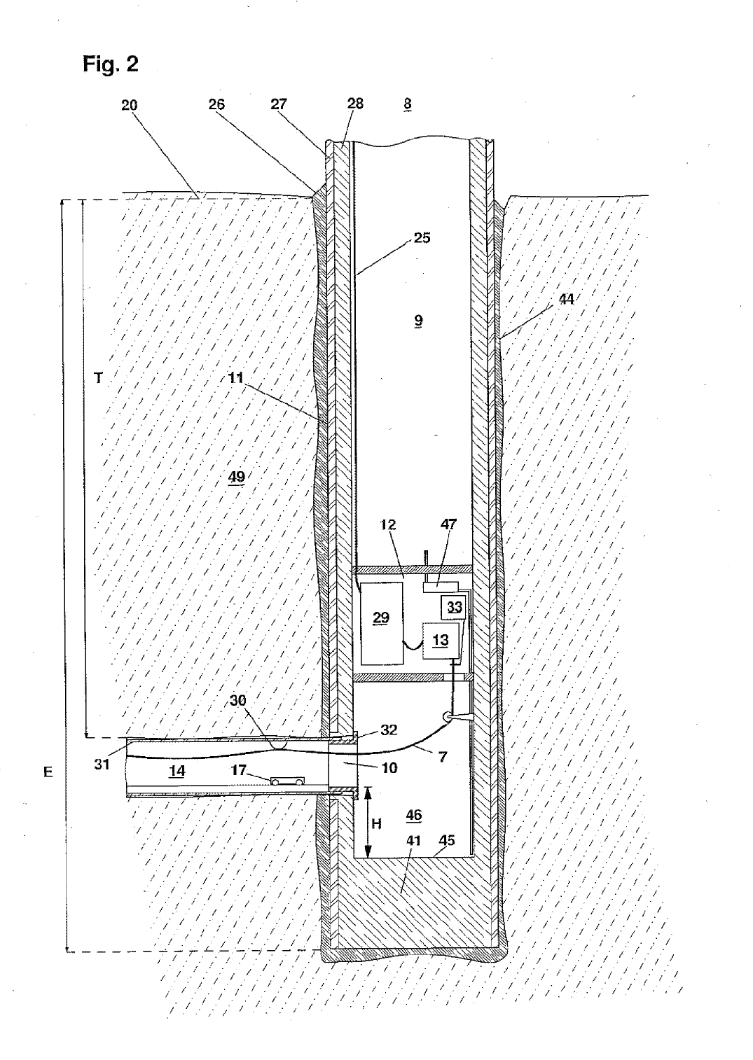

According to the invention, the offshore power generation plant 1 outlined in FIG. 1 has a cable passage 10 arranged on the foundation pile 9 below the ocean bed 20, through which an electrical connection cable 7 for power transmission is guided. For the preferred embodiment shown, the offshore power generation plant 1 comprises a cable tunnel 14 under the ocean bed 20, which adjoins the cable passage 10 and is designed as self-drying, so that the electrical connection cable 7 can be guided in air to a connection element 13 in a compartment within the foundation pile 9, which is created as a dry internal region 12. From there, an operating cable 25 extends to a power and supply plug 24 in the region of the coupling device 6, in which a coupling element 23 of the tower adapter 22 engages. In this way, a connection is caused between the nacelle 4 and the plant components located in the dry inner region 12. This will be described in greater detail hereafter on the basis of the enlarged illustration of FIG. 2.

FIG. 2 shows the operating cable 25 guided along the inner wall of the foundation pile 9, wherein this part of the foundation pile 9 can be embodied as flooded. The operating cable 25 enters in a pressure tight feedthrough (not shown in detail) into the dry inner region 12 on the foundation pile 9, which is located above the cable passage 10. A power and operating module 29, to which the operating cable 25 is guided, is arranged inside the dry inner region 12.

The electrical components and preferably further supply units of the offshore power generation plant 1 are combined in the power and operating module 29. These typically include rectifiers and an electrical transformer. Furthermore, preferably hydrostatic or pneumatic assemblies of the offshore power generation plants are combined in this power and operating module 29, which is located in the dry state. These can be used, for example, for the operation of a braking device of the power transducer 2 or for a hydrostatic starting aid for its mount on the nacelle 4. The operating cable 25 is accordingly not only used to transmit the power generated by the electrical generator 3, but rather also for guiding operating media such as hydraulic oil, compressed air, or lubrication or flushing media. Furthermore, the control components used for processing sensory data and for the operational control are housed within the power and operating module 29 in the dry inner region 12. The operating cable 25 accordingly preferably additionally comprises signal and control lines.

A connection element 13 for the electrical connection cable 7 is arranged inside the dry inner region 12. Connection terminals for the electrical connection cable 7 are most simply provided on the connection element 13. Furthermore, there is an electrical connection between the connection element 13 and the power and operating module 29 for power transmission. The connection preferably additionally comprises signal and control lines, which, accommodated in the electrical connection cable 7, lead away from the offshore power generation plant 1.

Furthermore, FIG. 2 shows an embodiment of the foundation pile 9 having an external steel pipe 27 on the outer wall 11, which has a breakthrough in the region of the cable passage 10. An initially closed concrete inner jacket 28 extends in the interior. This comprises a foundation pedestal 41, which terminates the outer steel pipe 27 of the foundation pile 9 in a watertight manner toward the bottom. The foundation pedestal 41 takes over the function of an additional ballast, in order to act like a keel during the insertion of the foundation pile 9 into a borehole 44 created on the ocean floor, which balances out the buoyancy effect of the dry inner region 12 and ensures the vertical insertion capability of the foundation pile 9 into the borehole 44.

For the embodiment shown in FIG. 2, the cable passage 10 and the cable tunnel 14 adjoining thereon are located at an exit depth T in the region of the lower third of the penetration depth E of the foundation pile 9. Furthermore, the cable passage 10 is arranged at a step height H above the floor region 45, so that a collection basin 46 arises in the lower part of the foundation pile, to which a bilge unit is assigned, in order to secure the plant against penetrating water. For this purpose, a bilge pump 47 is preferably arranged in the dry inner region 12, which can pump the water out of the collection basin 46 into the water-conducting part of the foundation pile 9 or to the outside region of the offshore power generation plant 1, respectively.

A tunnel connection 32 to the pressure resistant seal of the transition to the cable tunnel 14 is created in the region of the cable passage 10. Furthermore, the cable tunnel 14 has a liquid-tight tunnel lining 31 for the existing water pressure. This can be created in the form of tightly connected steel segments, for example, in the form of 120° partial arcs. A seawater-resistant, fiber-reinforced concrete inner wall can be used as an alternative tunnel lining 31, which is produced by means of a shotcrete method.

For the preferred embodiment shown in FIG. 2, a rail-based transport device 17 is created in the cable tunnel 14, which is designed for the material and/or personnel transport. Furthermore, for a preferred traversable embodiment, the cable tunnel 14 comprises safety and bulkhead systems and ventilation systems (not shown in detail).

After the preparation of the cable tunnel 14 and the cable passage 10 and the safety and sealing measures required for this purpose, the installation of the electrical connection cable 7 can be performed. For a preferred embodiment, a traction cable is output outward through the cable tunnel 14 up to the location of the cable drum on land or an offshore cavity on a cable retraction system 33, which is arranged in the region of the connection element 13 in the dry inner region 12. The electrical connection cable 7 can then be drawn in through the cable tunnel 14 up to the connection element 13 by means of the retraction movement of the traction cable. The electrical connection cable 7 is preferably mounted inside the cable tunnel 14 on cable mounts 30 at a distance to the inner wall of the tunnel lining 31.

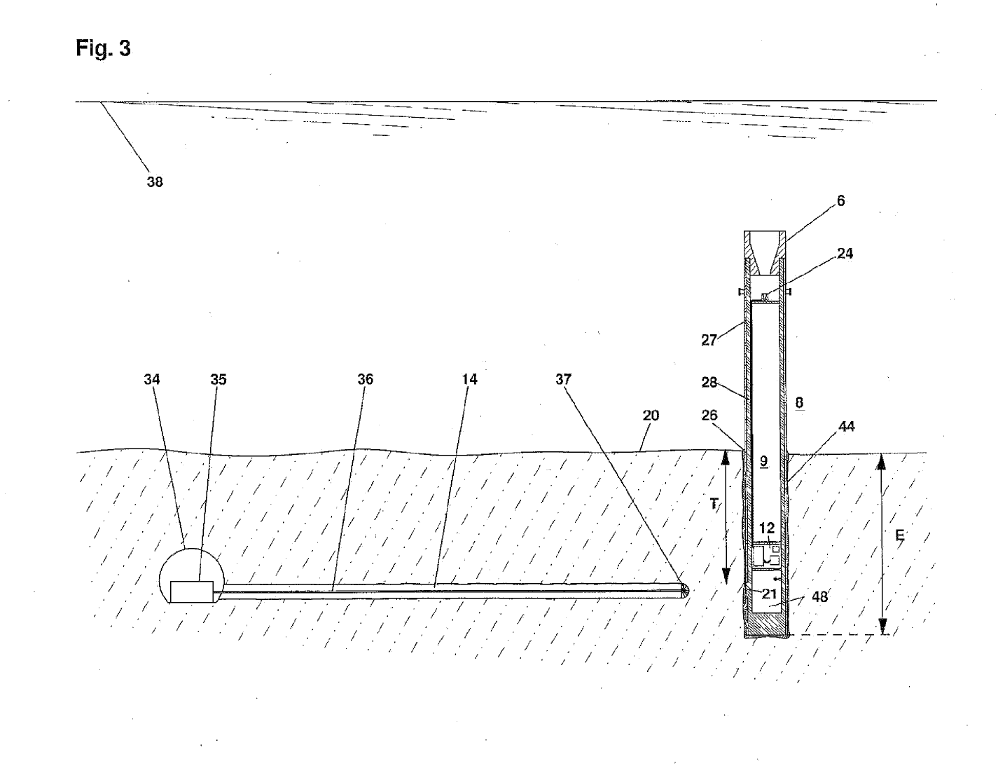

FIG. 3 shows a section of a preferred embodiment of the installation method according to the invention for connecting an electrical connection cable 7 via a cable tunnel 14 and a cable passage 10 having an exit depth T below the ocean bed 20. In a first method step, which is shown as already executed for FIG. 3, the foundation pile 9 is inserted at a penetration depth E under the ocean bed 20 into a borehole 44 and secured by cementing 26. In a further method step, horizontally oriented drilling is executed from a self-drying access tunnel 34 by means of a horizontal drilling machine 35. A drill pipe 36 having a drill head 37 is shown in schematically simplified form, wherein individual drill pipe segments can be supplied from a cavity (not shown in detail) in the region of the horizontal drilling machine 35.

The horizontally oriented borehole is guided up to a through-drilling point 21 on the foundation pile 9, which consists of a material which can be drilled through. An opening of the outer steel pipe 27 of the foundation pile 9 is preferably provided in the region of the through-drilling point 21. Furthermore, the reinforcement of the concrete inner jacket 28 is created in this region such that the drill head 37 can open the through-drilling point 21 to provide a cable passage 10. The above-described safety and sealing measures in the region of the cable tunnel 14 and the cable passage 10 are subsequently executed and the inlet chamber 48 located below the dry inner region 12 is drained. An access possibility to the dry inner region 12 then exists.

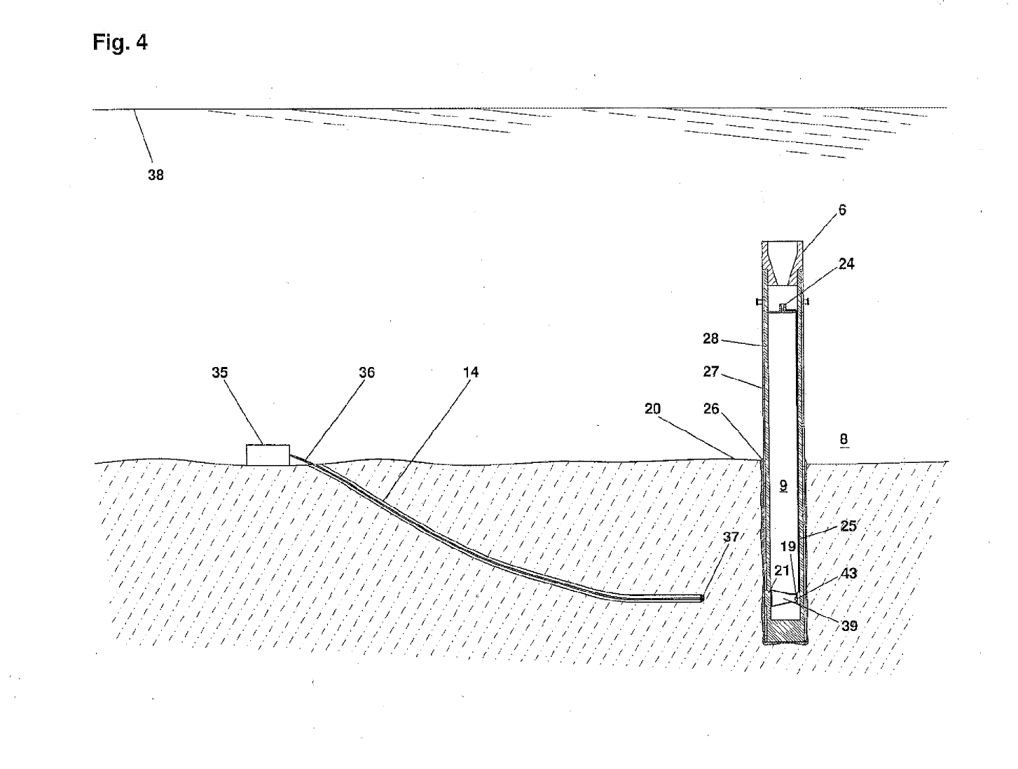

FIG. 4 outlines an alternative embodiment to provide the cable passage 10 below the ocean bed 20 on the foundation pile 9. For this exemplary embodiment, a horizontal drilling machine 35 on the ocean bed 20 is used, which creates an initially sinking cable tunnel 14, which conducts water for the present embodiment. FIG. 4 shows the drill head 37 in front of the through-drilling point 21 on the foundation pile 9. This is again created so it can be drilled, so that in the further course of the method, which is not shown in FIG. 4, the drill head provides a cable passage 10 on the foundation pile 9. A drill head guide 39 is attached to the rear of the through-drilling point 21, which guide centers the drill head and leads in the course of the further advance of the drill pipe 36 to a cable connection device 43. This preferably comprises a coupling device (not shown in detail) for connecting the drill head 37 with a traction cable wound up inside the cable connection device 43, which is drawn into the cable tunnel 14 during the retraction movement of the drill head 37. An electrical connection cable 7 can be coupled onto the traction cable thus laid in the cable tunnel 14, which can be drawn by means of an automated retrieving device for the traction cable, which is part of the cable connection device 43, into the cable tunnel 14.

Furthermore, the cable connection device 43 preferably comprises an automatic plug device 19, in order to join together a seawater-tight plug on the electrical connection cable 7 and a complementary connection part on the operating cable 25 in the region of the cable connection device 43. In this manner, a connection can be provided underwater from the power and supply plug 24 in the region of the coupling device 6, via the operating cable 25 and the seawater-proof plug in the region of the cable connection device 43, to the electrical connection cable 7 in the cable tunnel 14. From the drilling outlet at the location of the horizontal drilling machine 35 on the ocean bed 20, the electrical connection cable 7 can be embedded in the ocean floor by known measures, for example, by means of a water plow.

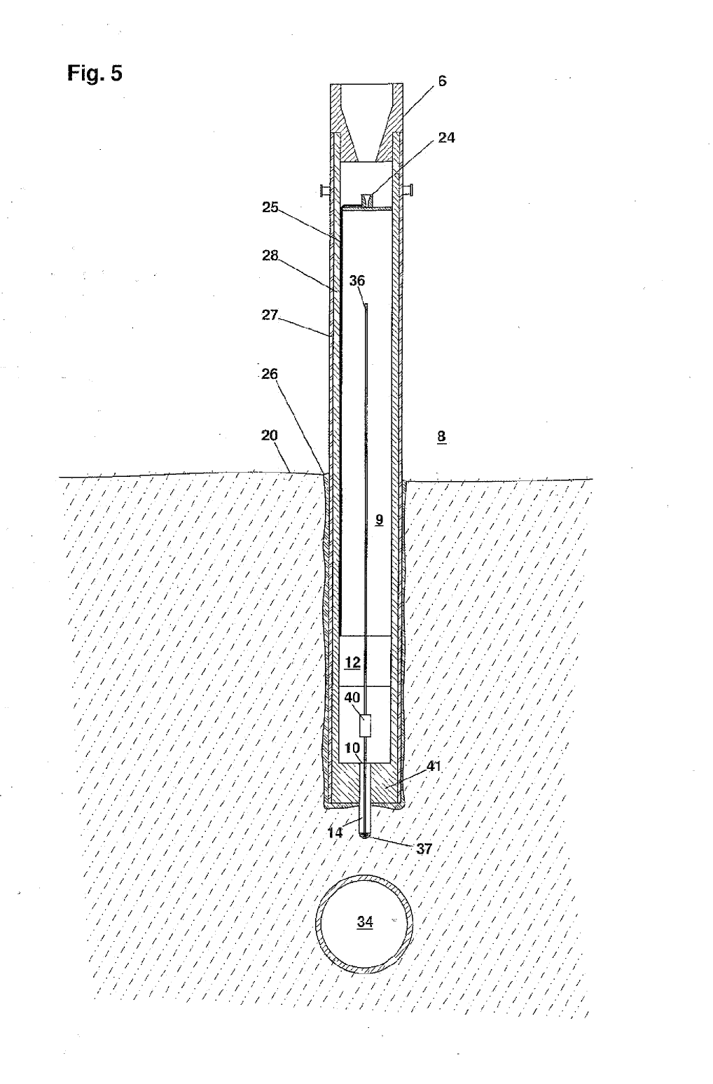

FIG. 5 shows a further embodiment alternative, for which the cable passage 10 on the foundation pile 9 is provided by means of a drilling device 40 operating outward from the interior of the foundation pile. An embodiment is shown for which the drill head 37 pierces through a concrete-filled foundation pedestal 41 at the base region of the foundation pile 9. The borehole is preferably guided to a self-drying access tunnel 34 leading along below the offshore power generation plant. The drilling device 40 together with the drill pipe 36 must accordingly be arranged in a dry compartment of the foundation pile 9.

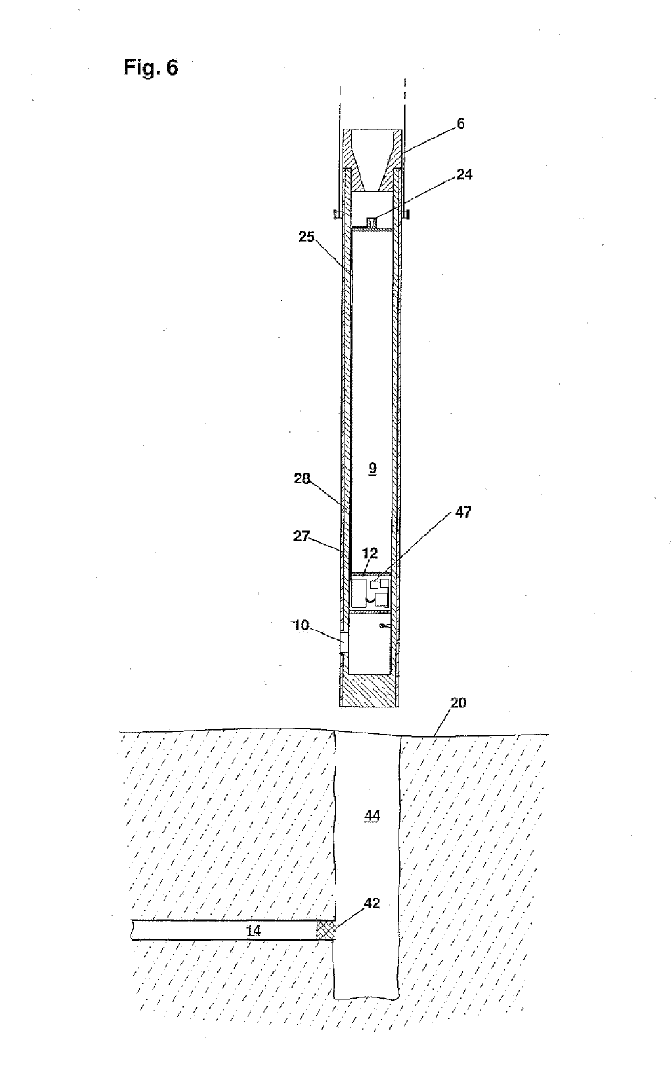

FIG. 6 shows a further embodiment of the invention, wherein the cable passage 10 is already provided before the insertion into the borehole 44 in the ocean floor. Accordingly, the foundation pile 9 for this embodiment variant must be installed with a predefined orientation and a predefined installation depth below the ocean bed 20, so that the cable passage 10 aligns with the cable tunnel 14 under the ocean bed 20. The cable tunnel 14 is initially protected by means of a sealing device 42. After the foundation pile 9 is cemented into the borehole 44, the entry region in the foundation pile 9 below the dry inner region 12 can be pumped free by a bilge pump 47.

For a simplified embodiment (not shown in detail), the cable tunnel 14 and the entire inner region of the foundation pile 9 are flooded, wherein the laying of the electrical connection cable is performed by means of a robot system. For this simplified embodiment, the sealing device 42 initially created in the cable tunnel 14 is only used as a protection for the cable passage and the cable tunnel during the cementing of the foundation pile 9. Alternatively, such a protection device can instead be created at the outlet of the cable tunnel 14 at the cable passage 10 of the foundation pile 9.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE NUMERALS

1 offshore power generation plant
2 power transducer
3 electric generator
4 nacelle
5 tower
6 coupling device
7 electrical connection channel
8 pile foundation
9 foundation pile
10 cable passage
11 outer wall
12 dry inner region
13 connection element
14 cable tunnel
17 transport device
18 cable guiding device
19 plug device
20 ocean bed
21 through-drilling point
22 tower adapter
23 coupling element
24 power and supply plug
25 operating cable
26 cementing
27 steel pipe
28 concrete inner jacket
29 power and operating module
30 cable mount
31 tunnel lining
32 tunnel connection
33 cable retraction system
34 access tunnel
35 horizontal drilling machine
36 drill pipe
37 drill head
38 water surface
39 drill head guide
40 drilling device
41 foundation pedestal
42 sealing device
43 cable connection device
44 borehole
45 floor region
46 collection basin
47 bilge pump
48 inlet chamber
49 ocean floor
50 steel sleeve
E penetration depth
H step height
T exit depth

What is claimed is:

1. An offshore power generation plant, comprising:
a power transducer configured for being driven by a fluid movement;
an electric generator configured for being at least indirectly driven by said power transducer;
an electrical connection cable for a power transmission;
a pile foundation including a foundation pile which extends under an ocean bed, said foundation pile including an outer wall; and
a cable passage which extends through said outer wall of said foundation pile, said cable passage being that through which said electrical connection cable is guided, said cable passage being arranged on said foundation pile below said ocean bed.

2. The offshore power generation plant according to claim 1, further including a connection element for said electrical connection cable, said foundation pile including a dry inner region therein, said connection element for said electrical connection cable being arranged in said dry inner region.

3. The offshore power generation plant according to claim 1, further including a cable tunnel which extends below said ocean bed, wherein said cable passage opens outside said foundation pile into said cable tunnel which extends below said ocean bed.

4. The offshore power generation plant according to claim 3, wherein said cable tunnel is implemented as liquid-tight.

5. The offshore power generation plant according to claim 4, wherein said cable tunnel includes an internal diameter and said electrical connection cable includes an external diameter, said internal diameter of said cable tunnel being created to be greater than said external diameter of said electrical connection cable.

6. The offshore power generation plant according to claim 5, wherein said cable tunnel at least one of (a) is traversable and (b) includes a transport device.

7. The offshore power generation plant according to claim 1, further including a cable guiding device and a plug device for said electrical connection cable, said foundation pile including an interior, said cable guiding device being arranged in said interior of said foundation pile, said cable guiding device adjoining said cable passage and leading to said plug device for said electrical connection cable.

8. A method for electrically connecting an offshore power generation plant, said method comprising the steps of:
driving, by a fluid movement, a power transducer;
driving, at least indirectly by said power transducer, an electrical generator;
providing a pile foundation including a foundation pile which extends under an ocean bed; and
drawing an electrical connection cable for a power transmission below said ocean bed through a cable passage which extends through an outer wall of said foundation pile.

9. The method according to claim 8, wherein said cable passage is opened after an erection of said foundation pile.

10. The method according to claim 9, wherein an opening of said cable passage is embodied by way of through drilling of said outer wall of said foundation pile.

11. The method according to claim 10, wherein a drilling for opening said cable passage is performed outward from an interior of said foundation pile.

12. The method according to claim 10, wherein a drilling for opening said cable passage is produced from an outside by way of a horizontally controlled drilling.

13. The method according to claim 12, wherein, by way of said horizontally controlled drilling, a cable tunnel is produced up to a through-drilling point on said foundation pile, and said cable passage is provided at said through-drilling point.

14. The method according to claim 13, wherein a liquid-tight connection is produced between said cable tunnel and said cable passage.

15. The method according to claim 8, wherein a prefinished said cable passage is created on said foundation pile, and said foundation pile is inserted into an ocean floor such that said cable passage aligns with a cable tunnel created below said ocean bed.
